(19) United States
(12) Patent Application Publication
(10) Pub. No.: US 2012/0231714 A1
(43) Pub. Date: Sep. 13, 2012

(54) Apparatus and method for feeding sausage chains to a suspension device

(75) Inventors: Harry Krompholz, Dorversen-Stedorf (DE); Peter Knodel, Oyten (DE); Jörg Bilowski, Delingsdorf (DE)

(73) Assignee: VEMAG MASCHINENBAU GMBH, Verden/Aller (DE)

(21) Appl. No.: 13/414,211

(22) Filed: Mar. 7, 2012

(30) Foreign Application Priority Data
Mar. 7, 2011 (DE) 10 2011 005 201.1

(51) Int. Cl. A22C 11/00

(52) U.S. Cl. 452/51

(57) ABSTRACT

The invention concerns an apparatus (1) for suspending sausage strings in loops (2), comprising a guide and drive device for guiding and driving hooks (8) along a path of movement, which has a drivable circulating drive element for spacedly receiving and for driving a plurality of hooks (8), and a plurality of hooks (8) which can be coupled to the drive element for carrying a loop (2) of the sausage string. The apparatus has a catch device (10) for catching a loop (2), which is arranged beneath and substantially radially outside the path of movement of the hooks. The invention further concerns a method of feeding sausage strings to an apparatus and a catch device.

### TECHNICAL FIELD

The present invention concerns an apparatus for suspending sausage strings in loops, comprising a guide and drive device for guiding and driving hooks along a path of movement, which has a drivable circulating drive element for spacedly receiving and for driving a plurality of hooks, and a plurality of hooks which can be coupled to the drive element for carrying a loop of the sausage string. The invention further concerns a method of feeding sausage strings to an apparatus for suspending sausage strings and a catch device for catching loops which can be suspended on an apparatus for suspending sausage strings.

### BACKGROUND

Sausages are usually produced with known sausage filling machines in the form of long portioned sausage strings. In that case, two adjacent sausage cases are respectively separated from each other by a twist-off location or a region filled with less sausage meat. The filled and divided sausage cases are made into loops and hung on a suspension apparatus. A smoking bar or rod is pushed through the loops of the sausages hanging from the suspension apparatus. The sausage string is then hung in that form on a smoking truck, which is then moved into a smoking chamber.

In that case, a suspension apparatus can have, for example, a circulating drum with hooks. In such an apparatus, the hooks rotate on the drum in such a way that in the feed movement a respective sausage loop is seized by a hook and is thus suspended thereon. In that respect, it is important that the sausages or loops are correctly suspended on the hooks and do not touch each other. That is of crucial significance in particular when smoke-curing the sausages. Otherwise, light spots would remain behind at the points of contact, and those spots not only detrimentally affect the outward appearance of the sausages, but also reduce the storage life thereof.

A further problem is transferring the individual loops to the suspension apparatus. In conventional apparatuses of the aforementioned kind, it frequently happens that loops are incorrectly suspended, individual loops are twisted, and the loops jump off the hooks. As a result it is frequently necessary for the individual loops to be correctly suspended and oriented by hand. That is a time-consuming and laborious operation. In particular, those problems occur at high feed speeds and when sausages collide.

A known apparatus for feeding sausage loops to a smoking bar is disclosed in EP 0 482 368 B1. That apparatus has a transport belt circulating in a horizontal plane and having a plurality of hooks. When the hooks pass the filling machine, twist-off locations between two sausages come into contact with a hook, and a loop is in that way suspended on the hook. In addition, that apparatus has a check bar and a holder which are arranged radially within the guide path of the hooks. The sausages are guided around the holder and over the check bar, whereby the aim is to prevent them from laterally veering off close to the exit from the filling machine so that the hook reliably comes into contact with the twist-off location.

Nonetheless, the above-mentioned problems still occur in that apparatus. In particular, due to the forced guidance of the sausages by the check bar, the sausages are put in a tensioned condition, whereby the loops can subsequently jump off the hooks. This apparatus also still suffers from the problem of a loop twisting.

### SUMMARY

An object of the present invention is to provide an apparatus and a method which are improved at least in respect of one of the aforementioned problems. A further object of the present invention is to provide an apparatus and a method by which the sausages are prevented from jumping down from the hooks and/or the feed speed of sausage strings to a suspension apparatus can be increased.

In an apparatus of the kind set forth in the opening part of this specification, that object is attained by a catch device for catching a loop, which is arranged beneath and substantially radially outside the path of movement of the hooks.

Such a catch device provides that the loops which are formed from a sausage string and which are suspended over the hook are caught in such a way that they are stabilized in their movement and individual loops are prevented from swinging to and fro. That avoids on the one hand twisting of a loop and also prevents a loop from jumping off the hook.

In the feed of sausage strings to a suspension apparatus, not every twist-off location is hung over a hook, but only every second, third, fourth, and so forth. Thus, there is a loop formed from a large number of sausages. A sausage string therefore firstly drops down before the next twist-off location to be seized is seized by a hook, and thus a loop is formed. In that process involving the sausage string dropping down to form the loop, the loops are spread and swing to and fro, and these are prevented by the catch device according to the invention. A loop is caught by the catch device directly after the formation of that loop, whereby the sausage loop is prevented from spreading open and a swinging movement thereof is prevented. The loop is also prevented from subsequently jumping off and down from the hook by the catch device according to the invention, insofar as the kinetic energy resulting from the feed and from loop formation is taken from the loop by the catch device and dissipated. For that purpose, the catch device is preferably adapted to catch a loop or a sausage string in a flying movement when same is being fed by a feed device to the suspension apparatus.

In accordance with a first preferred embodiment, the catch device is in the form of a loop member. The term loop member refers here to any configuration of a catch device, which has a configuration substantially corresponding to, or similar to, a loop. In that respect, it is possible to use, for example: curved bars, plates, a plurality of angled bars, bar portions connected to form a polygon, plate walls, curved grids, curved wire mesh, plastic pads, cushions, plastic mesh, etc. In particular, a sausage loop can advantageously be caught by means of such a loop member. In particular, the curved or bent form of the loop member is suitable for appropriately catching a sausage loop to be suspended, and simultaneously guiding the sausage loop into a desired position.

The sausage loop is gently caught and oriented by the loop member according to the invention.

In a further preferred embodiment, the loop member is of a substantially quarter-circular configuration, wherein the radius of that quarter circle is equal to or greater than the radius of the path of movement of the hooks. In particular, a quarter-circular form can be advantageously used if the hooks are circulating on a path of movement which is substantially oval and which is of a semicircular configuration at the apex points. The fact that the catch device is in the form of a quarter-circular loop member means that it can geometrically closely adapt to the path of movement of the hooks, and thus contributes to the loops being more gently caught and more greatly stabilized. In particular, it is advantageous if the radius of that quarter circle is of the same size as, or larger than the radius of the path of movement of the hooks. That leads to the loops being caught particularly gently and in such a way as to treat them carefully. The loops or sausage strings are not excessively forced to follow a path, but rather the natural movement of the loops is caught and stabilized. That leads to the loops being reliably suspended without the sausages jumping off. In addition, the feed speed of a feed machine can be increased.

In accordance with a further preferred embodiment, the catch device is displaceable preferably in a heightwise (i.e., vertical) direction, a longitudinal direction, and/or a transverse direction of the apparatus. The demands on a catch device can vary, for example, with feed speed and kind of sausages. The catch device being adjustable substantially increases the flexibility of the apparatus for suspending sausage strings, and also promotes reliably suspending the sausage strings on the hooks.

In a further preferred embodiment, the catch device is so arranged that as viewed from a hook it is arranged in a region of between about 20% and 90%, and in particular 20% and 60%, of the height of a loop of the sausage string. Arranging the catch device in that heightwise position of the apparatus relative to a hook is particularly advantageous as in that way the loops are particularly effectively stabilized, thereby preventing the loops from jumping off and turning. If the catch device is arranged excessively far upwardly, for example at 10% of the length of a loop of the sausage string as viewed from the hook, the result is that the catch device does not adequately prevent the loops from twisting or even jumping off the hooks. If the catch device is arranged too low, for example at 95% of the length of a loop, it can happen that the loop slips over the catch device, and thus a twist is still further increased.

In a further preferred embodiment, the catch device is arranged relative to the apparatus for suspending sausage strings in dependence on at least one of the following parameters: feed speed of a feed of sausage strings to the apparatus; number of sausages per loop; height of the loop in a suspended condition; mass of a sausage; ratio of the length of a twist-off location to the length of a sausage; firmness of a sausage; filling material; casing material; hook geometry; diameter of a sausage; length of a twist-off location; and temperature. All those parameters influence the loop formation behavior of a sausage string, and also the properties in respect of flying movement of the sausage string while it is being suspended. Arranging the catch device in dependence on one of those parameters, or a combination of at least two of those parameters, provides that the loop is still more effectively caught. In that way it is possible to prevent twisting of the loops and also prevent the loops from jumping off the hooks.

In a further preferred embodiment, the catch device as viewed from a hook is arranged at the height of the second sausage if a loop has four or six sausages; is arranged at the height of the third sausage if a loop has eight sausages; and arranged at the height of the fourth sausage if a loop has ten or twelve sausages. According to the invention, this provides an advantageous arrangement of the catch device in dependence on the parameter comprising the number of sausages per loop. In particular, it has been found that such an arrangement is advantageous to effectively catch a loop and avoid twisting of the loops. Such positioning of the catch device also avoids the loops jumping off the hooks so that the feed speed of the feed machine can be substantially increased.

In a further preferred embodiment, the catch device is arranged radially at a greater spacing from the path of movement if a feed speed is high, a sausage mass is low, and/or the number of sausages per loop is great, and is arranged radially at a smaller spacing from the path of movement if the feed speed is low, the sausage mass is high, and/or the number of sausages per loop is low. A radial spacing of the catch device relative to the path of movement of the hooks has substantial influence on a spreading-open movement of the loops, a swinging movement of the loops, and also guidance of the loops. If the catch device is arranged in the described manner in dependence on the feed speed, the sausage mass, or the number of sausages per loop, that effectively prevents the loops from undesirably spreading open and twisting, without the sausages being exposed excessively to a mechanical action thereon.

In a further aspect of the invention, the object is attained in a method of the kind set forth in the opening part of this specification by the steps of: feeding the sausage string from a filling machine to the apparatus, providing a hook for catching a twist-off location between two sausages, catching the twist-off location by means of the hook, and stabilizing a swinging loop by means of the catch device. In particular, the catch device is preferably designed as set forth by the features of the above-described catch device. Spreading-open movement of the loops, twisting of the loops, and the loops jumping off the hooks are effectively prevented by means of this method according to the invention. Stabilizing the loops in the fourth step of the method provides that energy, for example kinetic or oscillation energy, is dissipated from the loops, whereby they assume a calm hanging condition and an orderly arrangement on the hooks. Preferably the loops are stabilized in a region near the lower apex point, in spaced relationship with the hooks.

In an alternative or additional method of stabilizing loops on an apparatus for suspending sausage strings, such as, for example and in particular, an apparatus of the kind set forth in the opening part of this specification, the following steps are performed: determining a feed speed of a feed of sausage strings to the apparatus, determining a number of sausages per loop, determining a height of the loop in a suspended condition, and positioning the catch device at a location in dependence on the feed speed, the number of sausages per loop, and the height of the loops. In particular, such a method is advantageous in conjunction with the above-described apparatus and/or the above-described method.

In accordance with a further aspect of the invention, the object is attained in a catch device of the kind set forth in the opening part of this specification for catching loops, which can be suspended on an apparatus by the catch device being adapted to cooperate with an apparatus having the features of the above-described apparatus. Alternatively or additionally, the catch device according to the invention is adapted to be operated in a method having the features and steps of an above-described method. In particular, the catch device is in the form of a catch device as described hereinbefore, and/or has the features of an above-described catch device. Preferably, such a catch device is in the form of a loop member. In regard to the advantages, attention is directed to the above-described apparatus and the above-described method.

### BRIEF DESCRIPTION OF THE DRAWINGS

The invention is described in greater detail hereinafter by means of an embodiment by way of example with reference to the accompanying drawings in which:

FIG. 1 is an overall view of an apparatus for suspending sausage strings with a feed machine and a filling machine,

FIG. 2 is a detail view of a catch device on the apparatus for suspending sausage strings, and

FIG. 3 is a plan view of the catch device.

### DETAILED DESCRIPTION

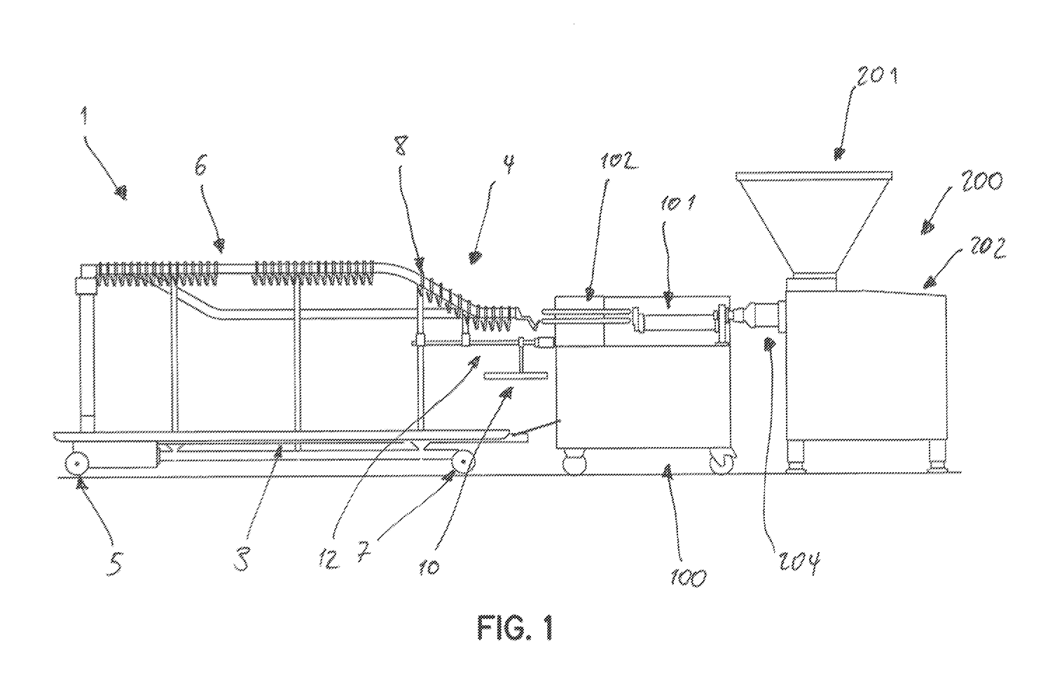

An apparatus 1 for suspending sausage strings is preferably arranged in a production line together with an accessory device 100 and a filling machine 200 (FIG. 1). The filling machine 200 has a machine frame 202 and a filling hopper 201, through which sausage meat can be fed. The sausage meat is fed to an accessory device 100 by a connecting tube 204. The device 100 has a holder 101 for a filling tube or a twist-off device (not shown) for producing twist-off locations 22, and two parallel belts 102 for conveying the twisted-off sausages to the apparatus 1 for suspending sausage strings.

The apparatus 1 has a frame 3 having rollers 5, 7 by way of which the apparatus 1 is arranged displaceably. Arranged on the frame 3 is a circulating receiving means 6 of hooks 8, which is of a rising configuration in a feed portion 4. A catch device 10 is arranged beneath the hooks 8 and beneath the belts 102 of the accessory device 100. The catch device 10 is connected to the frame 3 of the apparatus by means of a linkage 12. In this embodiment, the catch device 10 is in the form of a loop member, and is of a slight extent in a vertical direction. That means that the catch device is light and requires little material for the manufacture thereof. Alternatively, the catch device 10 is in the form of a plate. Such a plate is connected, for example, to a lower portion of the frame 3. Alternatively, the plate or catch device 10 is connected to the accessory device 100 or the filling machine 200.

The linkage 12, by means of which the loop member 10 is fixed to the frame 3 of the apparatus 1, has a first bar 14 connected to a second bar 18 by way of a connecting portion 16. The first bar 14 serves to orient the loop member 10 in a vertical direction, with respect to a usual orientation of the apparatus 1. The second bar 18 serves to orient the loop member 10 in a horizontal direction. The second bar 18 is connected to the frame 3 by way of a connecting location 20 so that the bar 18 can be fixed in various positions relative to the frame 3.

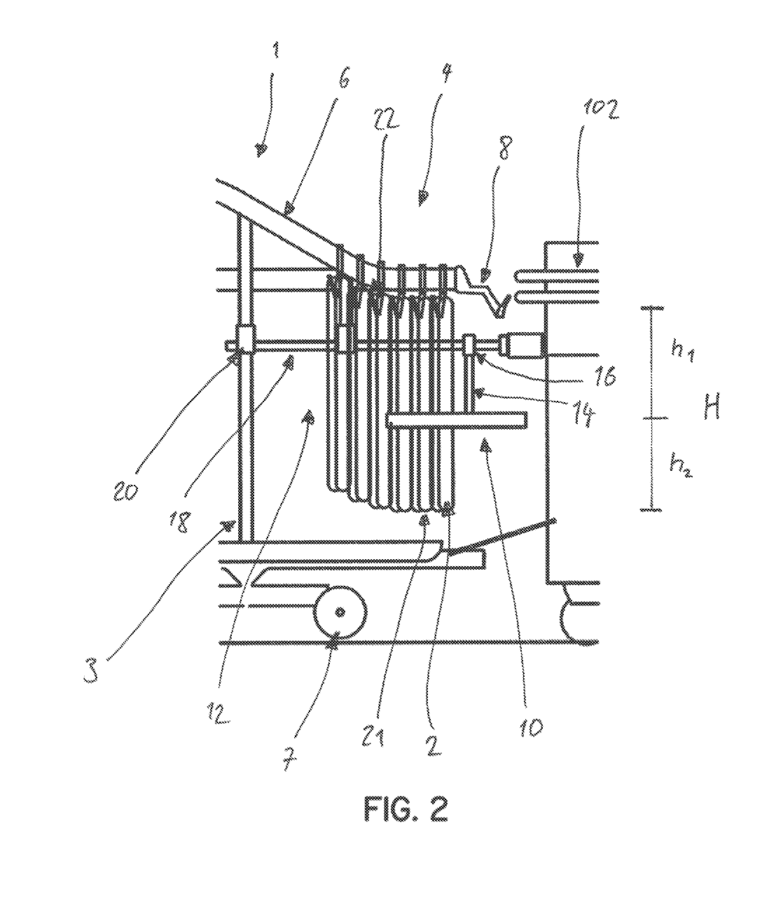

Referring to FIG. 2, this shows the hook 8 with suspended loops 2. In this case, a respective twist-off location 22 between two sausages is arranged at each hook 8. The vertical length of a loop is here shown as the height H between the twist-off location at an upper end of the loop 2 and the apex point at the lower end 21 of the loop 2. The loops 2 are only diagrammatically shown in FIG. 2. A loop 2 can be formed from two, three, four, etc. individual sausages.

Measured in the vertical height H, the loop member 10 is arranged at a spacing h₁ from the upper twist-off location 22 and thus from the hooks 8. The height h₁ is preferably selected so that the deflection of the sausage loop is limited to the maximum and the sausage loops do not jump over the loop member. In this embodiment h₁ is approximately 60% of H. If, as in this embodiment, the loop member 10 is of a relatively shallow configuration in relation to its vertical height, the positioning of the loop member 10 in relation to the height H is essential for securely suspending the loops 2 on the apparatus 1. Alternatively, the loop member is in the form of a plate and extends from a lower portion of the frame 3 towards the hooks. In such an embodiment, there is no need for adjustment of a vertical height of the loop member 10. The loop member 10 then preferably extends over the entire height H.

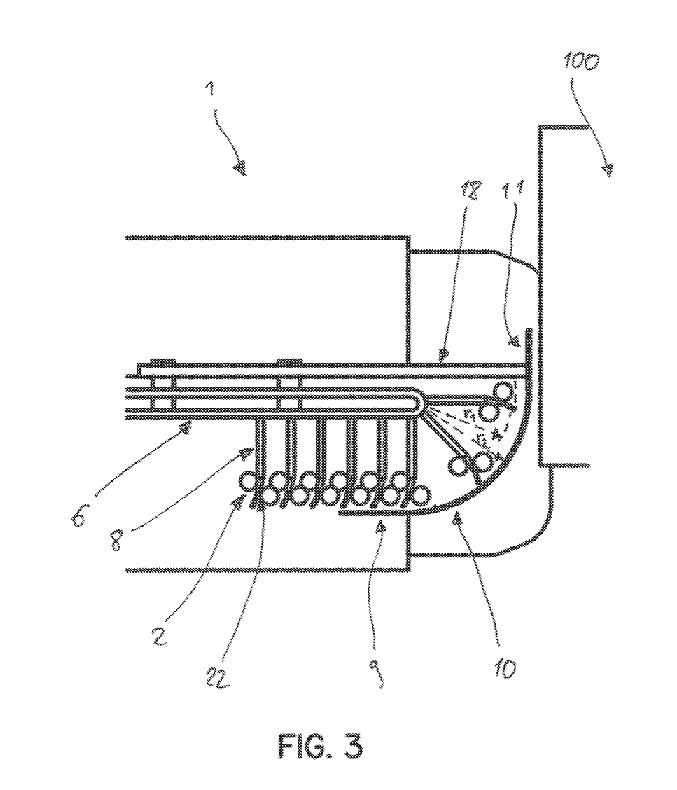

The loop member 10 is substantially in the form of a quarter-circular loop member 10 as shown in FIG. 3. The two ends 9, 11 of the loop member 10 are not curved but are straight. That shape of the loop member 10 contributes to effectively catching the loops 2 and effectively prevents the loops 2 from twisting and spreading.

In addition, the loop member 10 is arranged radially outside a path of movement of the hooks 8. In this embodiment, the quarter circle of the loop member 10 is of a radius r₂, which is larger than the radius r₁ of the path of circulating movement of the hooks 8. In this case, the radius r₂ is only slightly larger than the radius r₁, so that the loops 2 closely adapt to the loop member 10, and in particular in the end portion 9 thereof. Alternatively, the loop member 10 can be of a substantially larger radius r₂ and/or additional damping elements are arranged in the portion 9, the damping elements additionally stabilizing the loops 2 in order to prevent the loops 2 from twisting, spreading and jumping off the hooks 8.

The implementation of a method according to the invention of feeding sausage strings is effected in accordance with this embodiment as follows: after the twist-off locations 22 in a sausage string have been introduced by a twisting-off device (not shown) at the device 100, a sausage string is fed to the apparatus 1 by means of the parallel circulating belts 102. A corresponding hook 8 is provided by the apparatus 1 in such a way that the hook 8 engages into a twist-off location 22 between two sausages. After the hook 8 has caught the twist-off location 22 between two sausages the hook 8 moves along the rising region 4, the belts 102 further conveying the sausage string. As a result a falling loop 2 is then formed. That oscillating loop 2 is then stabilized in flight by means of the loop member 10 so as to ensure that the loop 2 is securely and reliably suspended on a hook. Then the next hook 8 comes into engagement with the next twist-off location, and a loop 2 is in turn formed, which in turn is caught by means of the loop member 10. Accordingly, the steps of the method are respectively performed sequentially, but can in part also take place simultaneously.

1-11. (canceled)

12. An apparatus for suspending a sausage string in loops from a plurality of hooks, each hook of the hooks configured to carry a loop of the sausage string, the apparatus comprising:
a guide and drive device that includes a drivable circulating drive element, the drive element configured to receive the plurality of hooks is a spaced relationship and to drive the plurality of hooks along a path of movement; and
a catch device configured to catch at least one of the sausage loops, the catch device arranged beneath and substantially radially outside the path of movement of the plurality of hooks.

13. The apparatus of claim 12, wherein the catch device is in the form of a loop member.

14. The apparatus of claim 13, wherein the loop member has a substantially quarter-circular configuration, and the radius of the substantially quarter-circular configuration is greater than or equal to the radius of the path of movement of the plurality of hooks.

15. The apparatus of claim 12, wherein the catch device is displaceable in one or more of a vertical direction, a longitudinal direction, or a transverse direction of the apparatus.

16. The apparatus of claim 12, wherein the catch device is arranged relative to a hook of the plurality of hooks from which the catch device is to receive one of the sausage loops such that the catch device is between about 0.2 and 0.9 of the height of the sausage loop below the hook.

17. The apparatus of claim 16, wherein the catch device is arranged so that the catch device is between about 0.2 and 0.6 of the height of the sausage loop below the hook.

18. The apparatus of claim 12, wherein the catch device is arranged relative to the apparatus for suspending a sausage string in dependence on at least one of the following parameters: a feed speed of the sausage string to the apparatus; a number of sausages per sausage loop; a height of the sausage loop in a suspended condition; a mass of a sausage; a ratio of the length of a twist-off location to the length of the sausage; a firmness of the sausage; a filling material of the sausage; a casing material of the sausage; a hook geometry; a diameter of the sausage; a length of the twist-off location; or a temperature.

19. The apparatus of claim 18, wherein the catch device is radially arranged at a greater spacing from the path of movement if the feed speed is high, the sausage mass is low, or the number of sausages per sausage loop is great.

20. The apparatus of claim 18, wherein the catch device is radially arranged at a smaller spacing from the path of movement if the feed speed is low, the sausage mass is high, or the number of sausages per sausage loop is low.

21. The apparatus of claim 12, wherein the catch device is arranged relative to a hook of the plurality of hooks from which the catch device is to receive a sausage loop at the height of a second sausage if the sausage loop has 4 or 6 sausages, at the height of a third sausage if the sausage loop has 8 sausages, or at the height of a fourth sausage if the sausage loop has 10 or 12 sausages.

22. A method of feeding a sausage string to an apparatus for suspending the sausage string in loops, the apparatus including a guide and drive device having a drivable circulating drive element that spacedly receives and drives a plurality of hooks along a path of movement, each hook of the plurality of hooks being coupleable to the drive element and configured to carry a loop of the sausage string, and a catch device that catches the sausage loop and that is arranged beneath and substantially radially outside the path of movement of the plurality of hooks, the method comprising:
feeding the sausage string from a filling machine to the apparatus;
providing a hook for catching a twist-off location between two sausages of the sausage string;
catching the twist-off location with the hook; and
stabilizing a swinging loop with the catch device.
